(19) United States
(12) Patent Application Publication
(10) Pub. No.: US 2008/0165285 A1
(43) Pub. Date: Jul. 10, 2008

(54) Auxiliary Input for Streaming Content to a Display Device

(75) Inventors: Kevin Thompson, Salem, OR (US); Jorell A. Olson, Portland, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: INFOCUS CORPORATION, Wilsonville, OR (US)

(21) Appl. No.: 11/969,598

(22) Filed: Jan. 4, 2008

Related U.S. Application Data
(60) Provisional application No. 60/883,723, filed on Jan. 5, 2007.

(51) Int. Cl. H04N 3/27

(52) U.S. Cl. 348/554; 348/E03.049

(57) ABSTRACT

An auxiliary input for streaming content to a display device is provided. One embodiment comprises assigning either a first input signal or a second input signal as a default signal to provide to a display device, monitoring the other of the first signal or the second signal for display content, and providing the other of the first signal or the second signal to the display device based on a state of the default signal.

### CROSS-REFERENCE TO RELATED APPLICATIONS

This application claims priority from U.S. Provisional Patent Application Ser. No. 60/883,723 of Kevin Thompson, and Jorell A. Olson, entitled “AUXILIARY INPUT FOR STREAMING CONTENT TO A DISPLAY DEVICE”, filed Jan. 05, 2007, the disclosure of which is hereby incorporated by reference in its entirety and for all purposes.

### FIELD

The present application relates to systems, apparatus and methods for streaming content to an image display device.

### BACKGROUND

Information display devices, also referred to herein as image devices or image display devices, may be used in a variety of environments. For example, information display devices, including, but not limited to televisions, monitors, and projectors may be adapted to display images, including text, graphics, video images, still images, presentations, etc. Such image devices may be found in home environments and applications, education environment and applications, business facilities, conference rooms and other meeting facilities, etc. The following is a non-exhaustive list of exemplary image devices: cathode ray tubes (CRTs), projectors, flat panel liquid crystal displays (LCDs) systems, LED systems, plasma systems, front projection systems, rear projection systems, LCD monitors, etc. Large format display devices may include but are not limited to televisions, front-projection systems, and rear-projections systems.

The images or content displayed on the image devices may be provided by a plurality of different content sources. For example, content may be provided by content sources or remote computing devices, including, but not limited to, computers, laptop computers, personal computers, storage mediums, such as memory cards and other memory devices, cameras, telephones, Smartphones, portable digital assistants, etc. Image data from the content source may be transmitted to the display device directly or through a network. The content source may be connected, e.g. wired or wirelessly, to the image device for display of the content.

Different content sources may include different types of connectors for coupling the content source to the image device. For example, known systems utilize a variety of types of cable technology for transmitting graphic and image data, for example, VESA connectors, Component systems, Composite systems, S-Video systems, M1-DA systems and HDMI systems. The range of connectors can increase the cost of image display systems, and can provide installation challenges in application environments. The various systems can also complicate the process of connecting a display device to a content source and enabling the content for display. Further, use of some of these systems with a display device may result in an initial delay period as the image device identifies the image source mode through standard methods of image source auto-detection. In other systems, content may be wirelessly transmitted to the image device.

The inventors herein have recognized that current systems are difficult to use in regards to switching between various content sources. Current solutions require a user to purchase a display system having multiple VESA inputs, or deploy a manual VESA switch inline, or manually disconnect one source and reconnect another source.

### SUMMARY

In one example, the inventors have identified a system and method for providing auto-detection and switching to/from wired data content depending on whether wireless content is available. One example embodiment comprises assigning either a first input signal or a second input signal as a default signal to provide to a display device, monitoring the other of the first signal or the second signal for display content, and providing the other of the first signal or the second signal to the display device based on a state of the default signal.

The inventors further have identified systems and methods to extend collaboration features in multiple-use scenarios, systems and methods to protect the existing wired installations, and means to add external wireless streaming receivers to enable image displays without consuming an extra video connection, such as a VESA connection, or requiring purchase of a new system with additional video inputs.

This Summary is provided to introduce a simplified form of concepts that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 shows a schematic depiction of an exemplary system for providing either wired or wireless display content to a display device.

FIG. 2 provides a schematic depiction of circuitry for auto-detection and switching of display content signals in an exemplary auxiliary input device.

FIG. 3 illustrates one embodiment settings table depicting video output settings according to the present disclosure.

FIG. 4 is a flow diagram illustrating a method of practicing an embodiment according to the present disclosure.

### DETAILED DESCRIPTION

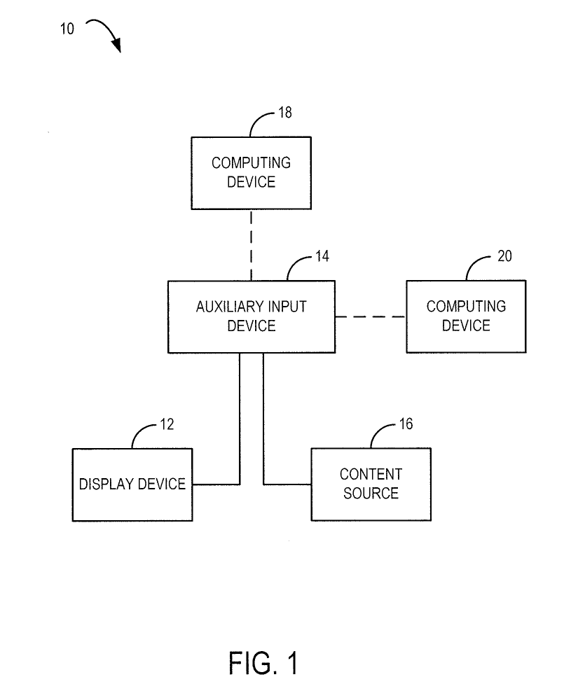

FIG. 1 illustrates an embodiment system 10 in accordance with the present disclosure. System 10 may include an image display device 12 coupled with an auxiliary input device 14. Auxiliary input device 14 is described below in more detail, but for illustration purposes is shown in system 10 coupled with computing device 18 and computing device 20 over wireless connections and with content source 16 over a wired connection. In one embodiment, auxiliary input device is coupled with display device 12 and content source 16 over a VESA connection. However, it should be appreciated that the disclosed system can be applied to any type of wired video connection, non-limiting examples include: DVI, HDMI, Component, Composite, S-Video, etc.

As discussed in the background, many home, corporate and education end-users are deploying wireless streaming media solutions to receive digital content from a remote computing device 18 (and 20) or a content source 16, wherein example computing devices and content sources include a laptop, PDA, smartphone, PC, etc. Further, this digital content is provided to a display device 12, such as a Large Format Display Device (LFDD). Although discussed in regards to implementation with LFDDs, it should be appreciated that this disclosure is not so limited and content may be streamed to other suitable display devices. In one embodiment, an auxiliary input device 14 may receive display content from at least one content source such as content source 16 over a first port, and display content from computing device 18 over a second port, and then provide display content from one of the content sources to display device 12 over a third port.

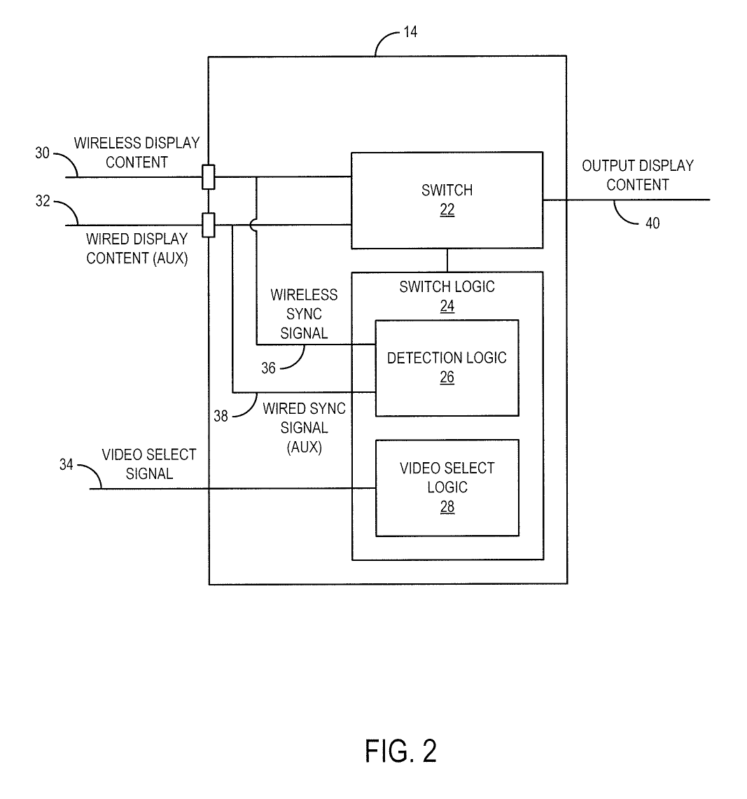

In some embodiments, auxiliary input device 14 may comprise circuitry coupled to each of the ports, wherein the circuitry is configured to provide for switching between wired and wireless data content dependent upon content availability. Some embodiments may be configured to automatically detect the presence or absence of a detection signal indicating wired or wireless data signal comprising display content, and may switch between the wired or wireless display content based on the detection. Other embodiments may provide display content to a display device based on a setting or other configurable preference, such as through a real-time input from a user interface. Aspects of these and other embodiments are described in more detail below with reference to FIGS. 2-4. It should be appreciated that this description is intended for illustrative purposes only and the disclosure is not so limited.

FIG. 2 provides a schematic depiction of an embodiment auxiliary input device 14 including circuitry for detection and switching of signals containing display content. In the present embodiment, auxiliary input device 14 includes a port to receive wireless display content 30, a port to receive wired display content 32 (Auxiliary display content), a port to output display content 40, and an input to receive a video select signal. Wireless display content 30 may be received through an antenna (not shown), and other embodiments may receive and output signals and/or content using other configurations than those shown in FIG. 2.

Auxiliary input device 14 is further illustrated with a switch logic 24 coupled with a switch 22. Switch logic 24 includes video select logic 28 to receive video select signal 34 (a control signal), and detection logic 26 to receive wireless sync signal 36 and wired sync signal 38 (Auxiliary). The present embodiment illustrates a simplified sync signal being input to detection logic, however, wireless sync signal 36 and wired sync signal 38 may be a vertical sync signal, a horizontal sync signal, or other signals understood in the art. Additionally, detection logic 26 may be triggered by suitable signals other than sync signals within the principles of this disclosure.

Accordingly, switch 22 receives at least a portion of either wireless display content 30 or wired display content 32, and provides output display content 40. For example, switch 22 may receive Red, Green and Blue (RGB) components of the wireless and wired display content, and may buffer them in an RGB buffered multiplexer. Some embodiments may have a separate sync multiplexer coordinated more closely with the switch logic 24, or other suitable arrangements to ensure the output video signal 40 is coordinated with the correct sync signals. In embodiment illustrated in FIG. 2, switch logic 24 provides switch 22 with the relevant sync signal, wherein the switch then may output display content 40 and the correct syncing signals.

In one embodiment, switch logic 24 may be configured to default to an input display content, for example the wired display content. Upon detection of the wireless sync signal 36, detection logic 26 may communicate with switch 22 to switch from the default wired display content 32 to the wireless display content 30.

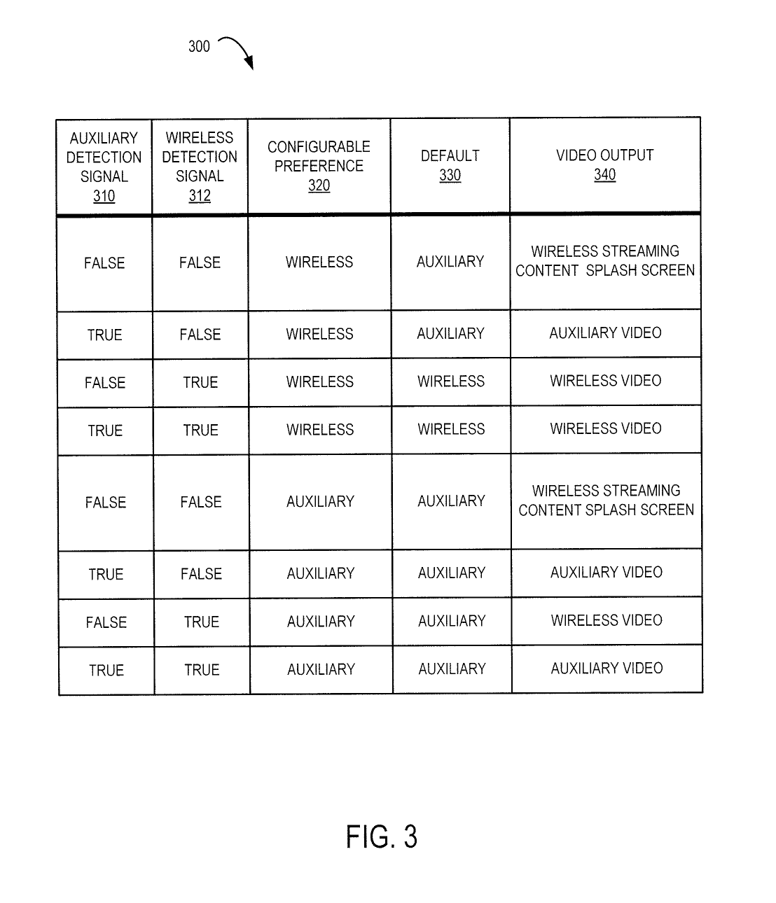

Some embodiments may use settings include the state of one or more input display content signals, user settings, default settings, etc., to determine which output display content 40 should be provided. FIG. 3 below provides a detailed example of a settings table. Referring back to FIG. 2, a user may input a video select signal, or otherwise adjust settings in video select logic 28, to provide a specific output display content 40. In a more detailed example, wired display content 32 may be previously set as the default display content to be output, but through a user interface coupled with video select signal 34, a user may over-ride the default setting and adjust video select logic 28 so that when detection logic 26 receives wireless sync signal 36, switch logic 24 is configured to command switch 22 to select wireless display content 30 for output.

In the present embodiment, detection logic 26 is illustrated receiving sync signals, but detection logic 26 may receive any input signal related to wireless display content 30 or wired display content 32. Further, the embodiment in FIG. 2 is simplified to illustrate switching and detection logic, a switch, multiple inputs, and an output display content. In practice, the output display content 40 includes the requisite sync signal, or the auxiliary input device otherwise provides any requisite sync signals along with output display content 40.

FIG. 3 illustrates a state table 300 depicting example output states for an embodiment according to the principles of this disclosure and as determined by a combination of input states, configurable preferences and default settings. Other tables may provide for a different output states as determined by combinations of input states, configurable preferences, default settings, etc., within the principles of this disclosure. Referring now to FIG. 3, table 300 is depicted with an auxiliary detection signal 310 column and a wireless detection signal 312 column that represent video input states. In one embodiment auxiliary detection signal 310 may be wired sync signal 38, and wireless detection signal 312 may be wireless sync signal 36, but other embodiments are not so limited. Table 300 also includes a column for configurable preference 320 state, a column for default 330 state, and a column for video output 340 state. The following paragraphs illustrate example use environments and configurations of auxiliary input device 14 in reference to the different states included in table 300. The following examples include a power on or reset configuration, a normal operation configuration, and a user control configuration. Again, it should be recognized that this disclosure of functional control is provided as an example and is not intended to limit the disclosure in any way.

Some embodiments may provide a power on, or reset, configuration. As an example, during a power on or a reset state, an auxiliary input device 14 may have a configurable preference for wireless display content, as is illustrated in rows 2 and 3 in the configurable preference 320 column in table 300. Other embodiments may have a configurable preference favoring wired display content at power on or reset. In a power on or reset configuration with a configuration preference for a wireless setting, while the wireless detection signal 312 is false, the video output 340 is configured to the auxiliary display content (wired) until the state of wireless detection signal 312 changes to true. This allows the auxiliary display content (wired) to be selected as the video output 340 during the absence of wireless video. If the auxiliary detection signal (wired) is not present, auxiliary input device 14 may display a wireless streaming content splash screen until a configurable preference 320 is set to wireless.

Continuing with the present example, a normal operation configuration may leave the power on (reset) configuration unchanged. This configuration may allow auto-switching from auxiliary display content (wired) to wireless display content, whereby a connected wired display content device may relinquish video output 340 signal (control of the display) by disabling video out from their laptop computing device. This is similar to performing an Fn-F5 or Fn-F8 keystroke entry (dependent on Laptop manufacture) to remote a laptop display to a projection device. When the auxiliary detection signal 310 is not present, or when a wireless detection signal is present, the default setting 330 may automatically switch to the wireless input, displaying the wireless streaming content splash screen or wireless display content if it is present.

In some embodiments, a default condition may cover a limited sub-set of use-scenarios that deploy a constant auxiliary display content (wired) input source connected to the auxiliary input device 14. Some example environments include meeting rooms and education settings where the environment requires a dedicated PC for projection. In many cases, this may be a dedicated or stand alone PC or a thin-client device, operating as an information server for a specific application. In this type of environment, a user control setting to select wireless as the configurable preference may be required to select Wireless Video as the video output.

Continuing with the present example, a user control configuration may favor the auxiliary video (wired). In this configuration, any condition that provides wired display content will automatically be displayed. In an example, this may be useful when there is a wireless and a wired presenter. In this way, a wireless presenter can be in a projecting state, but the video output 340 is the auxiliary video until the wired presenter performs configurable preference 320 change key entry. This configuration allows toggling between a wired display content source and a wireless display content source.

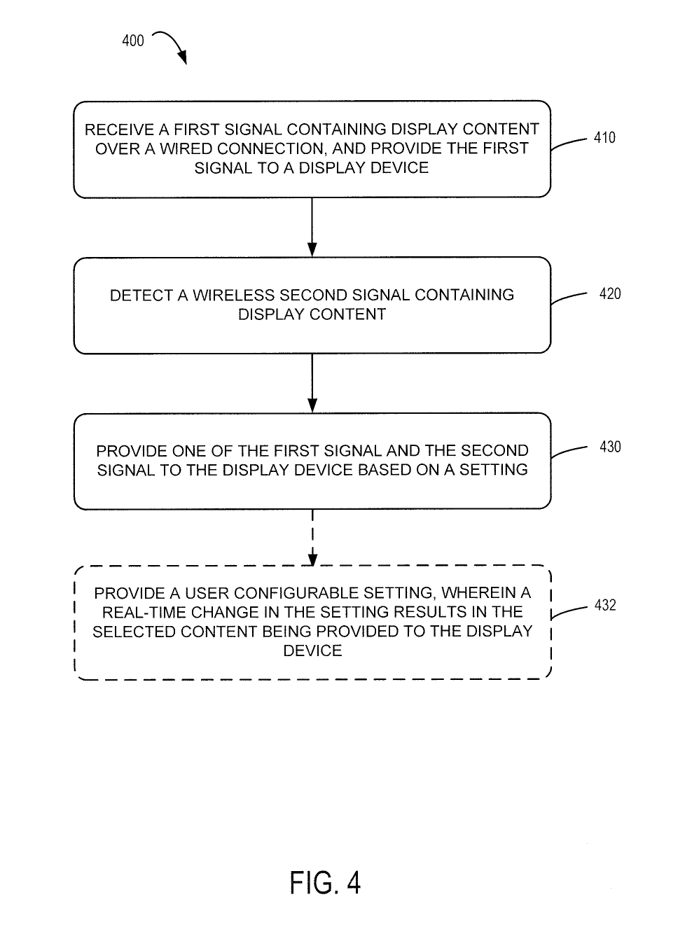

FIG. 4 is a flow diagram illustrating a method 400 of practicing an embodiment according to the present disclosure. Method 400 may be practiced in many environments, but for clarity in illustration, and in a non-limiting fashion, method 400 will be described in reference to auxiliary input device 14. First, in block 410, the method assigns either a first input signal or a second input signal as a default signal to supply to a display device. For example, the method may assign the wired signal as the default signal.

Next, in block 420, method 400 monitors an input to detect if the signal not set as the default signal is present. In one embodiment, method 400 may monitor the input for a sync signal, such as a horizontal sync signal or a vertical sync signal, but other embodiments are not so limited. For example, any part of an input video signal may provide enough indication to detect the presence of the signal not set as the default signal. In yet another embodiment, a dedicated signal may be used to signal the presence of an input signal comprising display content.

Next, in block 430, the method may provide the non-default signal to a display device based upon a setting or upon the state of either of the signals. Example settings are explained in the following paragraphs and also with reference to the system and apparatus in FIGS. 1 and 2 and the example settings table in FIG. 3, above. In some embodiments, method 400 may provide the non-default signal based upon a state of the default signal. In one example, when the default signal is inactive the display content from wireless input signal may be provided to the display device. For example, an auxiliary input device 14 may default to a connected wired input signal received from a content source. In some embodiments, the default signal is user selectable. Some embodiments may provide a user interface whereby settings may even be adjusted with a real-time user input, as is illustrated in optional block 432 in FIG. 4.

In some embodiments, an example setting may include uniquely identifiable information that may be used to determine which display content to provide a display device. Furthermore, settings may be adjusted to differentiate between signals when multiple signals are present. For example, if multiple wireless signals are present, an embodiment method may involve setting a preference for a MAC address associated with the wireless hardware of a specific device. Some embodiments may include a computer-readable medium comprising instructions executable by a computing device to execute the methods explained in reference to FIG. 4, or otherwise within this disclosure.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. In a display system containing an input device configured to receive a first signal over a wired connection from a first content source and a second signal over a wireless connection from a second content source, a method to provide display content from the input device to a display device, the method comprising:
assigning either the first signal or the second signal as a default signal to supply to a display device;
monitoring the other of the first signal or the second signal for display content; and
providing the other of the first signal or the second signal to the display device based on a state of the default signal and if there is display content on the other of the first signal or the second signal.

2. The method of claim 1, wherein providing the other of the first signal or the second signal further comprises providing the other signal when the default signal is inactive.

3. The method of claim 1, wherein the default signal is user selectable as either the first signal or the second signal.

4. The method of claim 1, further comprising providing the first signal or the second signal to the display device based on a real-time user input.

5. The method of claim 1, further comprising switching back to providing the default signal to the display device when the other of the first signal or the second signal is inactive.

6. The method of claim 1, wherein the display device is at least one of a cathode ray tube, a flat panel liquid crystal display, a plasma display, a light emitting diode display, a front projection display and a rear projection display.

7. The method of claim 1, wherein the content source is at least one of a laptop computer, a personal digital assistant, a smartphone, a media player, and a personal computer.

8. A computer-readable medium comprising instructions executable by a computing device to provide either a wired first signal to a display device or a wireless second signal to a display device, wherein the wired first signal and the wireless second signal are received from a content source, the instructions being executable to perform a method comprising:
receiving the first signal and providing the first signal to a display device;
detecting the second signal; and
providing one of the first signal and the second signal to the display device based on a setting.

9. The computer-readable medium of claim 8, wherein the setting sets either the first signal or the second signal as a default signal, wherein the default signal is sent to the display device if both signals are active.

10. The computer-readable medium of claim 8, wherein the setting is a real-time user input that sets either the first signal or the second signal as the signal to send to the display device.

11. The computer-readable medium of claim 8, further comprising instructions for providing the first signal to the display device when the second signal becomes inactive.

12. The computer-readable medium of claim 8, wherein the display device is at least one of a cathode ray tube, a flat panel liquid crystal display, a plasma display, a light emitting diode display, a front projection display and a rear projection display.

13. The computer-readable medium of claim 8, wherein the content source is at least one of a laptop computer, a personal digital assistant, a smartphone, a media player, and a personal computer.

14. An apparatus to receive display content from at least one content source and to provide the display content to a display device, the apparatus comprising:
a first port to receive a wired first signal comprising display content;
a second port to receive a wireless second signal comprising display content;
a third port to send display content to a display device; and
circuitry coupled to the first port, the second port, and the third port, wherein the circuitry is configured to provide one of the first signal and the second signal to the display device based on a setting.

15. Apparatus of claim 14, wherein the setting sets either the first signal or the second signal as a default signal, and the circuitry is configured to send the default signal to the display device if both signals are active.

16. Apparatus of claim 15, wherein the default signal is the first signal.

17. Apparatus of claim 16, wherein the circuitry is configured to provide the second signal to the display device when the first signal becomes inactive.

18. Apparatus of claim 17, wherein the circuitry is further configured to provide the second signal to the display device, and then provide the first signal to the display device when the second signal becomes inactive.

19. Apparatus of claim 14, wherein the setting is a real-time user input that sets either the first signal or the second signal as the signal to send to the display device.

20. Apparatus of claim 14, wherein the display device is at least one of a cathode ray tube, a flat panel liquid crystal display, a plasma display, a light emitting diode display, a front projection display and a rear projection display.

21. Apparatus of claim 14, wherein the content source is at least one of a laptop computer, a personal digital assistant, a smartphone, a media player, and a personal computer.
